(19) United States
(12) Patent Application Publication
(10) Pub. No.: US 2010/0225102 A1
(43) Pub. Date: Sep. 9, 2010

(54) BINDING SYSTEM

(76) Inventor: Guido Peleman, Antwerpen (BE)

Correspondence Address: BACON & THOMAS, PLLC, 625 SLATERS LANE, FOURTH FLOOR, ALEXANDRIA, VA, 22314-1176, US

(21) Appl. No.: 12/377,435

(22) PCT Filed: Jul. 27, 2007
(86) PCT No.: PCT/IB2007/002272

§ 371 Date: Feb. 13, 2009

(30) Foreign Application Priority Data
Aug. 16, 2006 (BE) 2006/0432

(51) Int. Cl. B42C 9/00; B42D 3/00

(52) U.S. Cl. 281/29; 412/37

(57) ABSTRACT

Binding system (1) provided with a binding back (2) on which is provided a layer of hot-setting adhesive (6), and at least one end leaf which consists of a leaf (8) made of a rigid material coated at least partly on at both sides with a layer of flexible material (9) extending at least on the side edge to be bound beyond the rigid leaf (8) so as to form a binding strip (10) with which the end leaf is fixed in the binding back (2), and wherein at least a part of the binding strip (10) is as thick or practically as thick as the thickness (D) of the end leaf.

The present invention concerns a binding system.

In particular, this invention concerns a binding system which serves for binding loose leaves and/or documents.

Binding systems that are formed of a metal, U-shaped binding back provided with a layer of glue on the inside that melts under the influence of heat, also called a hot-setting adhesive, whereby these binding systems are further provided with at least one end leaf formed of an actual leaf made of a rigid material that is coated on at least one side with a layer of flexible material extending at least on the side edge to be bound outside the stiff leaf so as to form a binding strip with which the end leaf is fixed in the binding back are already known.

When using such binding systems, a bundle of loose leaves and/or documents, including the above-mentioned at least one end leaf, is placed in the binding back together with the respective side edges to be bound.

Next, the binding back is heated so as to make the adhesive melt, after which the adhesive is finally cooled again so as to make it set, such that a bound bundle of leaves is obtained.

A disadvantage of such known binding systems is that the above-mentioned binding strip has only a limited thickness, such that a relatively heavy end leaf is provided in the adhesive via a restricted binding surface, as a result of which, when frequently opening and closing the bundle of bound leaves, said end leaf may come off the binding back.

Another disadvantage of the known binding systems is that the rigid leaves, which are usually made of hardboard, are relatively thick, whereas the thickness of the binding strip is restricted, such that, when binding the bundle of leaves in a binding back, the thickness of the bundle of leaves is considerably larger at the rigid leaf than the thickness at the binding back, as a result of which the bundles cannot be stacked in a uniform manner and there may be gaps between the binding backs, which looks rather sloppy.

Another disadvantage of such known binding systems is that the above-mentioned layer of flexible material is often made of polyvinylchloride (PVC) in which softening agents have been processed, as a result of which said layer of material does not adhere well in the above-mentioned layer of hot-setting adhesive.

Another disadvantage is that, when a bundle is bound whose thickness, together with the leaves to be bound, is somewhat larger than the opening of the binding back, the binding strips will be easily upset due to the friction with the walls of the binding back, which leads to a bad binding result, among others as the binding strips do not extend into the layer of adhesive.

The present invention aims to remedy one or several of the above-mentioned and other disadvantages.

To this end, the invention concerns a binding system that is provided with a binding back on which has been provided a layer of hot-setting adhesive, whereby this binding system is further provided with at least one end leaf formed of a leaf made of a rigid material that is at least partly coated with a layer of flexible material on at least one side extending on at least the side edge to be bound outside the rigid leaf so as to form a binding strip with which the end leaf is fixed in the binding back, whereby at least a part of the above-mentioned binding strip is as thick or practically as thick as the thickness of the end leaf.

An advantage of a binding system according to the invention is that the above-mentioned binding strip is relatively thick, such that the bonding surface of this binding strip in the layer of hot-setting adhesive is considerably larger than in the case of conventional binding systems, as a result of which a better bond is obtained and the end leaf will not come off the binding back.

Another advantage is that the bundles can be stacked back to back in a more uniform manner without any gaps between the binding backs, which is aesthetically advantageous.

Yet another advantage of a binding system according to the invention is that, thanks to the thicker layer of flexible material at the binding strip, this binding strip will also be more rigid, such that the bundle can be pushed in the back with more force without said strips thereby being upset.

The above-mentioned thickness of the binding strip is preferably realized in a simple manner by providing a strip of material on the protruding part of the layer of flexible material with the same or practically the same thickness as the rigid leaf.

According to a preferred characteristic of a device according to the invention, the above-mentioned strip of material is made of a material that adheres well in the above-mentioned layer of hot-setting adhesive, preferably of the same material as the rigid leaf, for example of cardboard.

This is advantageous in that a still better bond of the relatively heavy end leaf in the binding back can be obtained.

In order to better explain the characteristics of the invention, the following preferred embodiment of a binding system according to the invention is given as an example only without being limitative in any way, with reference to the accompanying drawings, in which:

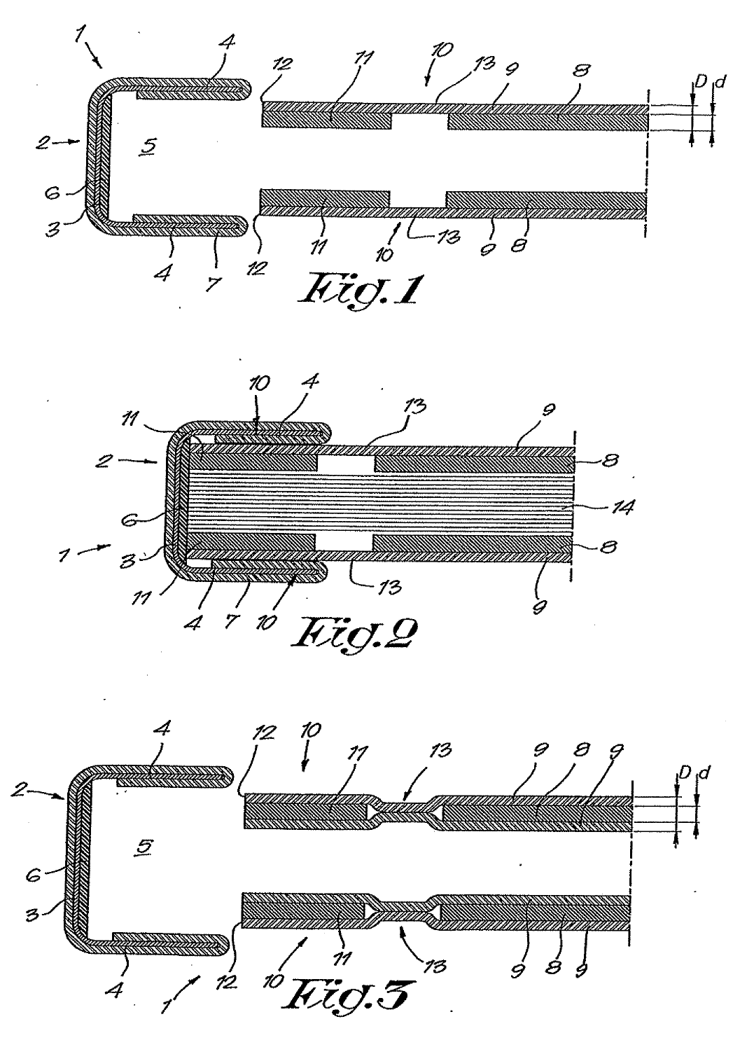

FIG. 1 schematically represents a binding system according to the invention, seen as a section;

FIG. 2 illustrates the use of a binding system according to FIG. 1;

FIG. 3 represents a variant of a binding system according to FIG. 1.

FIG. 1 schematically represents a binding system 1 according to the invention, provided with a binding back 2 which is in this case made as a U-shaped stud made of a heat-conducting material such as metal, whereby this U-shaped stud has a back wall 3 with two standing legs 4 confining a space 5.

In the space 5 is provided a layer of hot-setting adhesive 6 on the back wall 3.

In this case, but not necessarily, the above-mentioned binding back 2 is provided with a coating 7, for example made of paper, plastic, composite material or the like.

Further, the binding system 1 comprises at least one, and in this case two end leaves provided with an actual leaf 8 made of a rigid material, for example cardboard, whereby the leaves 8 are coated with a layer of flexible material 9, in this case on one side and preferably over their entire surface, which layer extends at least on the side edge to be bound outside said leaf 8 so as to form a flexible binding strip 10.

By a rigid material is meant in this case a material that is hardly pliable or not pliable at all, such as thick cardboard, hard plastic or the like, as is often used in highly qualitative binding systems.

In this case, but not necessarily, the above-mentioned layer of flexible material 9 is made of a flexible plastic such as polyvinylchloride.

Naturally, however, this layer of material 9 can also be made of other materials such as for example paper, fabric, composite material or the like.

According to the invention, at least a part of the binding strip is made as thick or practically as thick as the thickness D of the end leaf, as, in this case, a strip of material 11 is provided on at least a part of the above-mentioned binding strip 10 by means of gluing or the like, which strip is practically as thick as the rigid leaf 8 and which is made, according to a preferred characteristic, of a material such as cardboard or the like which adheres well to the above-mentioned layer of hot-setting adhesive 6.

Preferably, this strip of material 11 is made of a rigid material, for example the same material as that out of which the rigid leaf 8 is made, since a local reinforcement of the flexible binding strip 10 is thus obtained.

Preferably, the above-mentioned strip of material 11 extends at least up to the free edge 12 of the above-mentioned layer of material 9.

In the given example, the strip of material 11 is provided in such a manner on the binding strip 10 that it is situated at a distance from the leaf 8, such that between the rigid leaf 8 and the strip of material 11 is formed a flexible hinge strip 13.

The use of a binding system 1 according to the invention is very simple and is schematically represented in FIG. 2.

The loose end leaves are positioned in the binding back 2 with their above-mentioned binding strip 10, together with a bundle of leaves 14 to be bound.

The binding strips 10 are hereby put in the binding back 2 in such a manner that they are turned towards the bundle of leaves 14 with their respective strip of materials 11, whereas also the leaves 8 are turned towards this bundle of leaves 14.

Next, the binding back 2 is heated in an appropriate manner, as a result of which the hot-setting adhesive 6 that is present will start to melt and the leaves 14 and the binding strips 10 will sink in the adhesive 6.

Finally, the binding back 2 and thus also the adhesive 6 is cooled again, after which the adhesive 6 sets again, to thus form a bound whole.

Thanks to the larger thickness d of the strip of material 11 in relation to the known binding systems, a better bond in the adhesive 6 is obtained as the bonding surface is relatively large, and a nice, aesthetically bound whole is obtained whose thickness at the rigid Leaves 8 is equal to the thickness at the binding strips 10.

Thanks to the presence of the above-mentioned hinge strip 13, the rigid leaves 8 can nevertheless be easily opened and closed.

By manufacturing the strip of material 11 of a material that adheres well in the above-mentioned layer of hot-setting adhesive 6, such as cardboard or the like, a still better bond of the binding strips 10 in the binding back 2 is obtained.

It is clear that the end leaves can be printed beforehand, for example by means of a printer.

It is also clear that the strip of material 11 can be made as a whole with the layer of flexible material 9, for example as the layer of material 9 is folded back along the side to be bound or, in the case where the layer of material 9 is an extruded layer, by making it thicker at the binding strip 10.

It is preferably made sure hereby that the above-mentioned binding strip 10 is as thick or practically as thick, at least over a part thereof, as the thickness D of the end leaf at the rigid leaf 8.

FIG. 3 represents a variant of a binding system 1 according to the invention, whereby the rigid leaves 8 are in this case provided on either side of a layer of flexible material 9, and whereby this layer of material 9 extends on either side of the side edge to be bound outside the leaf 8 so as to form a flexible binding strip 10.

The above-mentioned binding strip 10 is provided with a strip of material 11 over at least part of its surface, which is practically as thick as the rigid leaf 8 and which is provided between the respective free parts of the layers of material 9, for example by means of gluing.

In this case as well, the strip of material 11 is situated at a distance from the leaf 8, such that between this strip of material 11 and the leaf 8 is formed a flexible hinge strip 13.

In this case, but not necessarily, the respective layers of material 9 provided on either side of the rigid leaf 8 at the above-mentioned hinge strip 13 are glued to each other.

The use of a binding system according to FIG. 3 is analogous to that of the above-described embodiment from FIG. 1.

As a coating in the form of a layer of flexible material 9 is in this case provided on either side of the leaves 8, a more solid cover is obtained for the bound whole.

In the given examples, the above-mentioned leaves 8 are provided with a layer of flexible material 9 over their entire surfaces, but naturally this layer of material 9 can also extend over only a part of the leaf 8.

It is clear that the above-mentioned material strip 11 must not necessarily extend over the entire length of the binding strip 10, but that it can also be provided on merely a part of the binding strip 10.

The above-mentioned layer of hot-setting adhesive must not necessarily be provided exclusively on the back wall 3 of the U-shaped stud, but it may also extend on one or both legs 4 of the binding back 2.

The above-mentioned binding back 2 must not necessarily be made in the shape of a U-shaped element, but it may also be formed of studs in other shapes.

The present invention is by no means limited to the embodiments given as an example and represented in the accompanying drawings; on the contrary, such a binding system according to the invention can be made in all sorts of shapes and dimensions while still remaining within the scope of the invention.

1-11. (canceled)

12. Binding system (1), comprising a binding back on which is provided a layer of hot-setting adhesive; at least one end leaf to be bound comprising a rigid material coated at least partly on both sides with layers of flexible material extending at least, at a side edge of the end leaf to be bound, beyond the end leaf side edge so as to form a binding strip with which the end leaf may be fixed in the binding back;
wherein at least a part of the binding strip is substantially as thick as the thickness of the end leaf and further wherein the layers of flexible material that extend beyond the side edge extend from both sides of the leaf; and wherein the binding strip includes an end strip of material that is located between the layers of flexible material over at least a portion of the binding strip.

13. Binding system according to claim 12, wherein the thickness of the binding strip that includes said end strip of material between the flexible layers of material extending beyond the side edge of the rigid end leaf is substantially the same thickness as the thickness of the rigid end leaf.

14. Binding system according to claim 13, wherein the end strip of material is a material that adheres well to the hot-setting adhesive.

15. Binding system according to claim 13, wherein the end strip of material comprises cardboard.

16. Binding system according to claim 12, wherein the end strip of material is disposed on the binding strip in such a manner that it is located at a distance from the rigid end leaf side edge, so that a flexible hinge strip of flexible material layers is left between the end leaf side edge and the end strip of material.

17. Binding system according to claim 16, wherein the end strip of material extends at least up to free edges of the flexible layers of material.

18. Binding system according to claim 12, wherein the end strip of material comprises a rigid material.

19. End leaf for use in a binding system according to claim 12, comprising a rigid material that is coated at least partly on both sides with a flexible layer of material which extends at least, at the side edge to be bound, beyond the side edge so as to define a binding strip, and wherein at least a part of the binding strip is substantially as thick as the thickness of the end leaf.
